(19) United States
(12) Patent Application Publication
(10) Pub. No.: US 2026/0081732 A1
(43) Pub. Date: Mar. 19, 2026

(54) DOPPLER OFFSET REPORTING FOR COHERENT JOINT-TRANSMISSION

(71) Applicant: QUALCOMM Incorporated, San Diego, CA (US)

(72) Inventors: Wei Xi, Beijing (CN); Jing Dai, Beijing (CN); Liangming Wu, Beijing (CN); Hao Xu, Beijing (CN)

(21) Appl. No.: 19/108,659

(22) PCT Filed: Nov. 4, 2022
(86) PCT No.: PCT/CN2022/129762

§ 371 Date: Mar. 4, 2025

(51) Int. Cl. H04L 5/00; H04W 24/10

(52) U.S. Cl. CPC H04L 5/0035; H04L 5/0048; H04W 24/10

(57) ABSTRACT

This disclosure provides systems, methods, and devices for wireless communication that support Doppler offset reporting for coherent joint-transmission (CJT) communications. In a first aspect, a method of wireless communication includes measurement by a user equipment (UE) of a Doppler offset indication for each cooperative transmission-reception point (TRP) of multiple TRPs in CJT communications with the UE. The UE would report the Doppler offset indication to the serving TRP, which forwards the Doppler offset indication to each corresponding cooperative TRP. Each cooperative TRP may then use the Doppler offset indication to adjust downlink CJT communications with the UE. Other aspects and features are also claimed and described.

### TECHNICAL FIELD

Aspects of the present disclosure relate generally to wireless communication systems, and more particularly, to coherent joint-transmission (CJT) between a user equipment and a plurality of cooperative transmission-reception points (TRPs). Some features may enable and provide improved communications, including Doppler offset reporting for CJT communications.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station or other network entity.

A network entity may transmit data and control information on a downlink to a UE or may receive data and control information on an uplink from the UE. On the downlink, a transmission from the network entity may encounter interference due to transmissions from neighbor network entities or from other wireless radio frequency (RF) transmitters. On the uplink, a transmission from the UE may encounter interference from uplink transmissions of other UEs communicating with the neighbor network entities or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a user equipment (UE) in coherent joint-transmission (CJT) communication with a serving transmission-reception point (TRP) and one or more cooperative TRPs is disclosed. The method includes estimating a Doppler spectrum for each cooperative TRP of the one or more cooperative TRPs, wherein the Doppler spectrum is estimated using a downlink reference signal of the each cooperative TRP relative to the downlink reference signal of the serving TRP, calculating a Doppler offset indication for the each cooperative TRP, wherein the Doppler offset indication is between the Doppler spectrum for the each cooperative TRP as observed from the serving TRP and a carrier frequency of the downlink reference signal of the serving TRP, and transmitting a report to the serving TRP, wherein the report includes the Doppler offset indication for the each cooperative TRP.

In an additional aspect of the disclosure, a method of wireless communication performed by a cooperative TRP in CJT communication with a serving TRP and a UE, the method including receiving a Doppler offset indication from the serving TRP, and transmitting downlink CJT communications to the UE, wherein the downlink CJT communications are adjusted for transmission in accordance with the Doppler offset indication.

In an additional aspect of the disclosure, a UE configured for wireless communication and in CJT communication with a serving TRP and one or more cooperative TRPs. The UE includes at least one processor, and a memory coupled to the at least one processor.

The at least one processor is configured to estimate a Doppler spectrum for each cooperative TRP of the one or more cooperative TRPs, wherein the Doppler spectrum is estimated using a downlink reference signal of the each cooperative TRP relative to the downlink reference signal of the serving TRP, to calculate a Doppler offset indication for the each cooperative TRP, wherein the Doppler offset indication is between the Doppler spectrum for the each cooperative TRP as observed from the serving TRP and a carrier frequency of the downlink reference signal of the serving TRP, and to transmit a report to the serving TRP, wherein the report includes the Doppler offset indication for the each cooperative TRP.

In an additional aspect of the disclosure, a cooperative TRP configured for wireless communication and in CJT communication with a serving TRP and a UE. The cooperative TRP includes at least one processor, and a memory coupled to the at least one processor. The at least one processor is configured to receive a Doppler offset indication from the serving TRP, and transmit downlink CJT communications to the UE, wherein the downlink CJT communications are adjusted for transmission in accordance with the Doppler offset indication.

In an additional aspect of the disclosure, a UE, configured for wireless communication and in CJT communication with a serving TRP and one or more cooperative TRPs, is disclosed. The UE includes means for estimating a Doppler spectrum for each cooperative TRP of the one or more cooperative TRPs, wherein the Doppler spectrum is estimated using a downlink reference signal of the each cooperative TRP relative to the downlink reference signal of the serving TRP, means for calculating a Doppler offset indication for the each cooperative TRP, wherein the Doppler offset indication is between the Doppler spectrum for the each cooperative TRP as observed from the serving TRP and a carrier frequency of the downlink reference signal of the serving TRP, and means for transmitting a report to the serving TRP, wherein the report includes the Doppler offset indication for the each cooperative TRP.

In an additional aspect of the disclosure, a cooperative TRP, configured for wireless communication and in CJT communication with a serving TRP and a UE, is disclosed. The cooperative TRP includes means for receiving a Doppler offset indication from the serving TRP, and means for transmitting downlink CJT communications to the UE, wherein the downlink CJT communications are adjusted for transmission in accordance with the Doppler offset indication.

In an additional aspect of the disclosure, a non-transitory computer-readable medium stores instructions that, when executed by a processor, cause the processor to perform operations including estimating, by a UE, a Doppler spectrum for each TRP of one or more cooperative TRPs in CJT communication with a serving TRP and the UE, wherein the Doppler spectrum is estimated using a downlink reference signal of the each cooperative TRP relative to the downlink reference signal of the serving TRP, calculating a Doppler offset indication for the each cooperative TRP, wherein the Doppler offset indication is between the Doppler spectrum for the each cooperative TRP as observed from the serving TRP and a carrier frequency of the downlink reference signal of the serving TRP, and transmitting a report to the serving TRP, wherein the report includes the Doppler offset indication for the each cooperative TRP.

In an additional aspect of the disclosure, a non-transitory computer-readable medium stores instructions that, when executed by a processor, cause the processor to perform operations including receiving, by a cooperative TRP in CJT communications with a serving TRP and a UE, a Doppler offset indication from the serving TRP, and transmitting downlink CJT communications to the UE, wherein the downlink CJT communications are adjusted for transmission in accordance with the Doppler offset indication.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating a wireless network having a UE in CJT communications with multiple TRPs each entity capable of supporting Doppler offset reporting for CJT communications according to aspects of the present disclosure.

FIG. 4 is a flow diagram illustrating an example process that supports Doppler offset reporting for CJT communications according to one or more aspects.

FIG. 5 is a block diagram illustrating a wireless network having a UE in CJT communications with multiple TRPs each entity supporting Doppler offset reporting for CJT communications according to one or more aspects.

FIG. 6 is a flow diagram illustrating an example process that supports Doppler offset reporting for CJT communications according to one or more aspects.

FIG. 7 is a block diagram of an example UE that supports Doppler offset reporting for CJT communications according to one or more aspects.

FIG. 8 is a block diagram of an example network entity that supports Doppler offset reporting for CJT communications according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support Doppler offset reporting for CJT communications. Particular implementations of the subject matter described in this disclosure may be implemented to realize one or more of the following potential advantages or benefits. In some aspects, the present disclosure provides techniques for Doppler offset reporting for CJT communications. The problem of outdated CSI in CJT communications can be greatly alleviated or even completed solved. More precise and “less outdated” CSI can improve the system performance of CJT communications. Compared to the conventional solution of increasing the frequency of CSI reporting, implementing the reporting of Doppler offset indications can reduce CSI-RS overhead, can reduce CSI reporting overhead, and can reduce UE computational complexity.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “mmW” band.

The frequencies between FR1 and FR2 are often referred to as mid-band frequencies. Recent 5G NR studies have identified an operating band for these mid-band frequencies as frequency range designation FR3 (7.126 GHZ-24.25 GHZ). Frequency bands falling within FR3 may inherit FR1 characteristics and/or FR2 characteristics, and, thus, may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2x (52.6 GHZ-71 GHz), FR4 (71 GHz-114.25 GHZ), and FR5 (114.25 GHZ-275 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmW” or the like if used herein may broadly represent frequencies that may include mid-band frequencies, may be within FR2, FR2x, FR4, and/or FR5, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmW transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmW components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

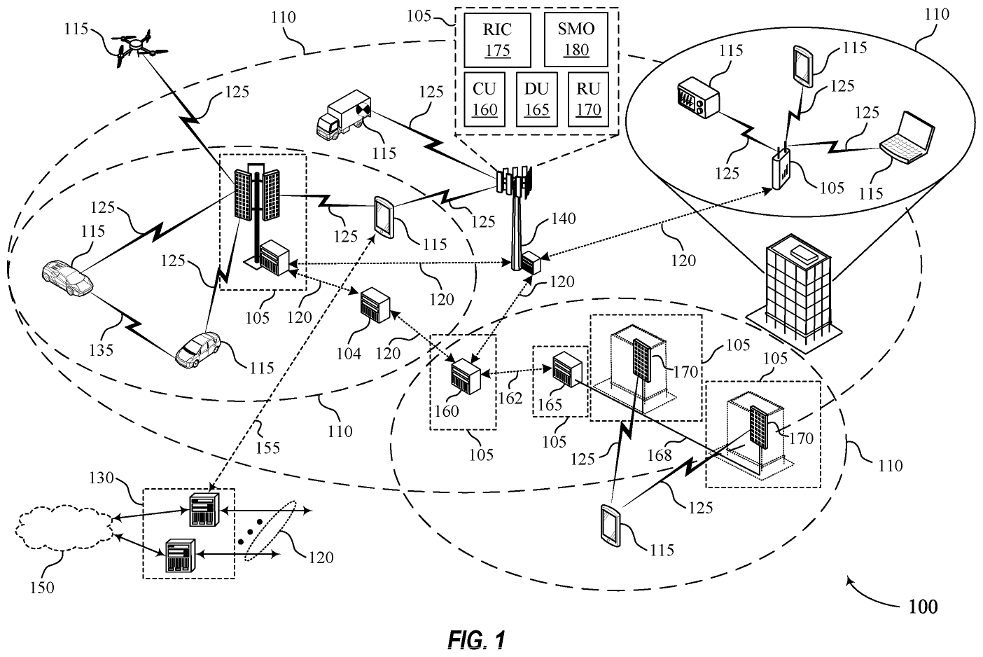

FIG. 1 illustrates an example of a wireless communications system 100 that supports scheduling requests for spatial multiplexing in accordance with one or more aspects of the present disclosure. Wireless communications system 100 may include one or more network entities 105, one or more UEs 115, and a core network 130. In some examples, wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

Network entities 105 may be dispersed throughout a geographic area to form wireless communications system 100 and may include devices in different forms or having different capabilities. In 3GPP, the term “cell” may refer to this particular geographic coverage area of a network entity, such as network entities 105, or a network entity subsystem serving the coverage area, depending on the context in which the term is used. In various examples, network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, network entity 105 may support a coverage area 110 (e.g., a geographic coverage area) over which UEs 115 and network entity 105 may establish one or more communication links 125. Coverage area 110 may be an example of a geographic area over which network entity 105 and UE 115 may support the communication of signals according to one or more radio access technologies (RATs).

UEs 115 may be dispersed throughout coverage area 110 of the wireless communications system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115 or network entities 105, as shown in FIG. 1.

As described herein, a node of wireless communications system 100, which may be referred to as a network node, or a wireless node, may be network entity 105 (e.g., any network entity described herein), UE 115 (e.g., any UE described herein), a network controller, an apparatus, a device, a computing system, one or more components, or another suitable processing entity configured to perform any of the techniques described herein. For example, a node may be UE 115. As another example, a node may be network entity 105. As another example, a first node may be configured to communicate with a second node or a third node. In one aspect of this example, the first node may be UE 115, the second node may be network entity 105, and the third node may be UE 115. In another aspect of this example, the first node may be UE 115, the second node may be network entity 105, and the third node may be network entity 105. In yet other aspects of this example, the first, second, and third nodes may be different relative to these examples. Similarly, reference to UE 115, network entity 105, apparatus, device, computing system, or the like may include disclosure of UE 115, network entity 105, apparatus, device, computing system, or the like being a node. For example, disclosure that UE 115 is configured to receive information from network entity 105 also discloses that a first node is configured to receive information from a second node.

In some examples, network entities 105 may communicate with core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over backhaul communication link 120 (e.g., in accordance with an X2, Xn, or other interface protocol) either directly (e.g., directly between network entities 105) or indirectly (e.g., via core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. Backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. UE 115 may communicate with core network 130 through a communication link 155.

One or more of network entities 105 described herein may include or may be referred to as base station 140 (e.g., a base transceiver station, a radio base station, an NR base station, an access point, a radio transceiver, a transmission-reception point (TRP), a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, network entity 105 (e.g., base station 140) may be implemented in an aggregated (e.g., monolithic, standalone) base station architecture, which may be configured to utilize a protocol stack that is physically or logically integrated within a single network entity 105 (e.g., a single RAN node, such as base station 140).

In some examples, network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. RU 170 may also be referred to as a radio head, a smart radio head, a remote radio head (RRH), a remote radio unit (RRU), or a transmission reception point (TRP). One or more components of network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between CU 160, DU 165, and RU 175 is flexible and may support different functionalities depending upon which functions (e.g., network layer functions, protocol layer functions, baseband functions, RF functions, and any combinations thereof) are performed at CU 160, DU 165, or RU 175. For example, a functional split of a protocol stack may be employed between CU 160 and DU 165 such that CU 160 may support one or more layers of the protocol stack and DU 165 may support one or more different layers of the protocol stack. In some examples, CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). CU 160 may be connected to one or more DUs 165 or RUs 170, and one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by CU 160.

Additionally, or alternatively, a functional split of the protocol stack may be employed between DU 165 and RU 170 such that DU 165 may support one or more layers of the protocol stack and RU 170 may support one or more different layers of the protocol stack. DU 165 may support one or multiple different cells (e.g., via one or more RUs 170). In some cases, a functional split between CU 160 and DU 165, or between DU 165 and RU 170 may be within a protocol layer (e.g., some functions for a protocol layer may be performed by one of CU 160, DU 165, or RU 170, while other functions of the protocol layer are performed by a different one of CU 160, DU 165, or RU 170). CU 160 may be functionally split further into CU control plane (CU-CP) and CU user plane (CU-UP) functions. CU 160 may be connected to one or more DUs 165 via midhaul communication link 162 (e.g., F1, F1-c, F1-u), and DU 165 may be connected to one or more RUs 170 via fronthaul communication link 168 (e.g., open fronthaul (FH) interface). In some examples, midhaul communication link 162 or fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of RU 170) of IAB node 104 used for access via DU 165 of IAB node 104 (e.g., referred to as virtual IAB-MT (vIAB-MT)). In some examples, IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between core network 130 and the AN (e.g., via a wired or wireless connection to core network 130). That is, an IAB donor may refer to a RAN node with a wired or wireless connection to core network 130. The IAB donor may include CU 160 and at least one DU 165 (e.g., and RU 170), in which case CU 160 may communicate with core network 130 over an interface (e.g., a backhaul link). IAB donor and IAB nodes 104 may communicate over an F1 interface according to a protocol that defines signaling messages (e.g., an F1 AP protocol). Additionally, or alternatively, CU 160 may communicate with the core network over an interface, which may be an example of a portion of backhaul link, and may communicate with other CUs 160 (e.g., CU 160 associated with an alternative IAB donor) over an Xn-C interface, which may be an example of a portion of a backhaul link.

IAB node 104 may refer to a RAN node that provides IAB functionality (e.g., access for UEs 115, wireless self-backhauling capabilities). DU 165 may act as a distributed scheduling node towards child nodes associated with IAB node 104, and the IAB-MT may act as a scheduled node towards parent nodes associated with IAB node 104. That is, an IAB donor may be referred to as a parent node in communication with one or more child nodes (e.g., an IAB donor may relay transmissions for UEs through one or more other IAB nodes 104). Additionally, or alternatively, IAB node 104 may also be referred to as a parent node or a child node to other IAB nodes 104, depending on the relay chain or configuration of the AN. Therefore, the IAB-MT entity of IAB nodes 104 may provide a Uu-interface for a child IAB node 104 to receive signaling from parent IAB node 104, and the DU interface (e.g., DUs 165) may provide a Uu-interface for parent IAB node 104 to signal to child IAB node 104 or UE 115.

For example, IAB node 104 may be referred to as a parent node that supports communications for a child IAB node, and referred to as a child IAB node associated with an IAB donor. The IAB donor may include CU 160 with a wired or wireless connection (e.g., backhaul communication link 120) to core network 130 and may act as parent node to IAB nodes 104. For example, DU 165 of IAB donor may relay transmissions to UEs 115 through IAB nodes 104, and may directly signal transmissions to UE 115. CU 160 of IAB donor may signal communication link establishment via an F1 interface to IAB nodes 104, and IAB nodes 104 may schedule transmissions (e.g., transmissions to UEs 115 relayed from the IAB donor) through DUs 165. That is, data may be relayed to and from IAB nodes 104 via signaling over an NR Uu-interface to MT of IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support scheduling requests for spatial multiplexing as described herein. For example, some operations described as being performed by UE 115 or network entity 105 (e.g., base station 140) may additionally, or alternatively, be performed by one or more components of the disaggregated RAN architecture (e.g., IAB nodes 104, DUs 165, CUs 160, RUs 170, RIC 175, SMO 180).

UE 115 may include or may be referred to as a mobile device, a wireless device, a remote device, a handheld device, or a subscriber device, or some other suitable terminology, where the “device” may also be referred to as a unit, a station, a terminal, or a client, among other examples. UE 115 may also include or may be referred to as a personal electronic device such as a cellular phone, a personal digital assistant (PDA), a tablet computer, a laptop computer, or a personal computer. In some examples, UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, a satellite radio, a global positioning system (GPS) device, a global navigation satellite system (GNSS) device, a logistics controller, an unmanned aerial vehicle (UAV), a drone, a smart energy or security device, a solar panel or solar array, etc. among other examples.

UEs 115 described herein may be able to communicate with various types of devices, such as other UEs 115 that may sometimes act as relays as well as network entities 105 and the network equipment including macro eNBs or gNBs, small cell eNBs or gNBs, or relay base stations, among other examples, as shown in FIG. 1.

UEs 115 and network entities 105 may wirelessly communicate with one another via one or more communication links 125 (e.g., an access link) over one or more carriers. The term “carrier” may refer to a set of RF spectrum resources having a defined physical layer structure for supporting communication links 125. For example, a carrier used for communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communications system 100 may support communication with UE 115 using carrier aggregation or multi-carrier operation. UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between network entity 105 and other devices may refer to communication between the devices and any portion (e.g., entity, sub-entity) of network entity 105. For example, the terms “transmitting,” “receiving,” or “communicating,” when referring to network entity 105, may refer to any portion of network entity 105 (e.g., base station 140, CU 160, DU 165, RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with UE 115.

One or more numerologies for a carrier may be supported, where a numerology may include a subcarrier spacing (Δf) and a cyclic prefix. A carrier may be divided into one or more BWPs having the same or different numerologies. In some examples, UE 115 may be configured with multiple BWPs. In some examples, a single BWP for a carrier may be active at a given time and communications for UE 115 may be restricted to one or more active BWPs.

The time intervals for network entities 105 or UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of UEs 115. For example, one or more of UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific one of UEs 115.

In some examples, network entity 105 (e.g., base station 140, RU 170) may be movable and therefore provide communication coverage for a moving one of coverage areas 110. In some examples, a different one of coverage areas 110 associated with different technologies may overlap, but the different one of coverage areas 110 may be supported by the same one of network entities 105. In some other examples, the overlapping coverage areas 110 associated with different technologies may be supported by different ones of network entities 105. Wireless communications system 100 may include, for example, a heterogeneous network in which different types of network entities 105 provide coverage for various coverage areas 110 using the same or different radio access technologies.

Some of UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or network entity 105 (e.g., base station 140) without human intervention. In some examples, M2M communication or MTC may include communications from devices that integrate sensors or meters to measure or capture information and relay such information to a central server or application program that makes use of the information or presents the information to humans interacting with the application program. Some of UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some of UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for UEs 115 include entering a power saving deep sleep mode when not engaging in active communications, operating over a limited bandwidth (e.g., according to narrowband communications), or a combination of these techniques. For example, some of UEs 115 may be configured for operation using a narrowband protocol type that is associated with a defined portion or range (e.g., set of subcarriers or resource blocks (RBs)) within a carrier, within a guard-band of a carrier, or outside of a carrier.

Wireless communications system 100 may be configured to support ultra-reliable communications or low-latency communications, or various combinations thereof. For example, wireless communications system 100 may be configured to support ultra-reliable low-latency communications (URLLC). UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within coverage area 110 of network entity 105 (e.g., base station 140, RU 170), which may support aspects of such D2D communications being configured by or scheduled by network entity 105. In some examples, one or more UEs 115 in such a group may be outside coverage area 110 of network entity 105 or may be otherwise unable to or not configured to receive transmissions from network entity 105. In some examples, groups of UEs 115 communicating via D2D communications may support a one-to-many (1:M) system in which each UE 115 transmits to each of the other ones of UEs 115 in the group. In some examples, network entity 105 may facilitate the scheduling of resources for D2D communications. In some other examples, D2D communications may be carried out between UEs 115 without the involvement of network entity 105.

In some systems, D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

Core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 served by network entities 105 (e.g., base stations 140) associated with core network 130. User IP packets may be transferred through the user plane entity, which may provide IP address allocation as well as other functions. The user plane entity may be connected to IP services 150 for one or more network operators. IP services 150 may include access to the Internet, Intranet(s), an IP Multimedia Subsystem (IMS), or a Packet-Switched Streaming Service.

Wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between UEs 115 and network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

Wireless communications system 100 may utilize both licensed and unlicensed RF spectrum bands. For example, wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as network entities 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

Network entity 105 (e.g., base station 140, RU 170) or UE 115 may be equipped with multiple antennas, which may be used to employ techniques such as transmit diversity, receive diversity, multiple-input multiple-output (MIMO) communications, or beamforming. The antennas of network entity 105 or UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with network entity 105 may be located in diverse geographic locations. Network entity 105 may have an antenna array with a set of rows and columns of antenna ports that network entity 105 may use to support beamforming of communications with UE 115. Likewise, UE 115 may have one or more antenna arrays that may support various MIMO or beamforming operations. Additionally, or alternatively, an antenna panel may support RF beamforming for a signal transmitted via an antenna port.

Network entities 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., network entity 105, UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Network entity 105 or UE 115 may use beam sweeping techniques as part of beamforming operations. For example, network entity 105 (e.g., base station 140, RU 170) may use multiple antennas or antenna arrays (e.g., antenna panels) to conduct beamforming operations for directional communications with UE 115. Some signals (e.g., synchronization signals, reference signals, beam selection signals, or other control signals) may be transmitted by network entity 105 multiple times along different directions. For example, network entity 105 may transmit a signal according to different beamforming weight sets associated with different directions of transmission. Transmissions along different beam directions may be used to identify (e.g., by a transmitting device, such as network entity 105, or by a receiving device, such as UE 115) a beam direction for later transmission or reception by network entity 105.

Some signals, such as data signals associated with a particular receiving device, may be transmitted by a transmitting device (e.g., transmitting network entity 105, transmitting UE 115) along a single beam direction (e.g., a direction associated with the receiving device, such as receiving network entity 105 or receiving UE 115). In some examples, the beam direction associated with transmissions along a single beam direction may be determined based on a signal that was transmitted along one or more beam directions. For example, UE 115 may receive one or more of the signals transmitted by network entity 105 along different directions and may report to network entity 105 an indication of the signal that UE 115 received with a highest signal quality or an otherwise acceptable signal quality.

In some examples, transmissions by a device (e.g., by network entity 105 or UE 115) may be performed using multiple beam directions, and the device may use a combination of digital precoding or beamforming to generate a combined beam for transmission (e.g., from network entity 105 to UE 115). The UE 115 may report feedback that indicates precoding weights for one or more beam directions, and the feedback may correspond to a configured set of beams across a system bandwidth or one or more sub-bands. Network entity 105 may transmit a reference signal (e.g., a cell-specific reference signal (CRS), a channel state information reference signal (CSI-RS)), which may be precoded or unprecoded. UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by network entity 105 (e.g., base station 140, RU 170), UE 115 may employ similar techniques for transmitting signals multiple times along different directions (e.g., for identifying a beam direction for subsequent transmission or reception by UE 115) or for transmitting a signal along a single direction (e.g., for transmitting data to a receiving device).

A receiving device (e.g., UE 115) may perform reception operations in accordance with multiple receive configurations (e.g., directional listening) when receiving various signals from a receiving device (e.g., network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between UE 115 and network entity 105 or core network 130 supporting radio bearers for user plane data. At the PHY layer, transport channels may be mapped to physical channels.

UEs 115 and network entities 105 may support retransmissions of data to increase the likelihood that data is received successfully. Hybrid automatic repeat request (HARQ) feedback is one technique for increasing the likelihood that data is received correctly over a communication link (e.g., communication link 125, D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

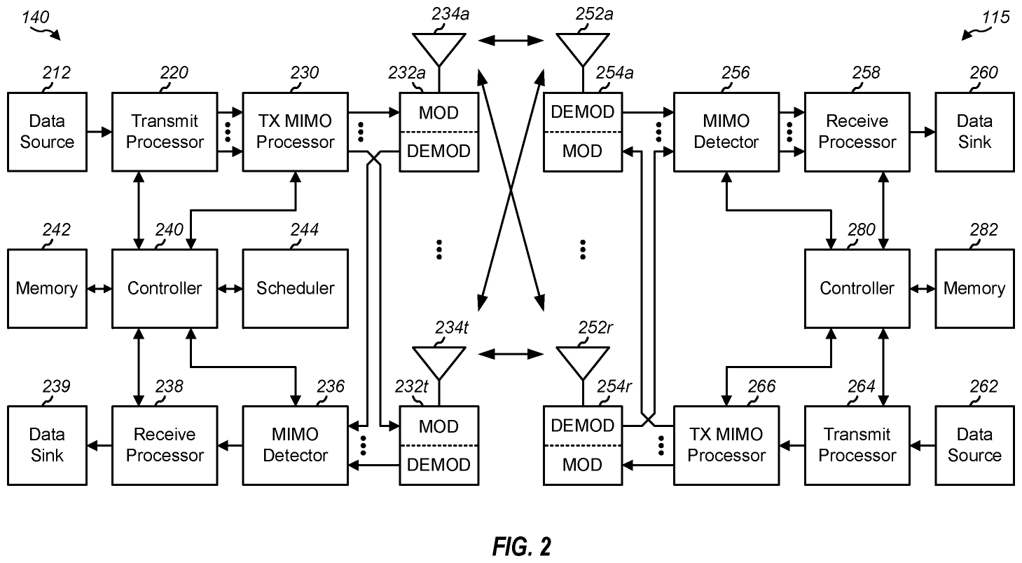

FIG. 2 is a block diagram illustrating examples of base station 140 and UE 115 according to one or more aspects. Base station 140 and UE 115 may be any of the network entities and base stations and one of the UEs in FIG. 1. For a restricted association scenario (as mentioned above), network entity 105 may be small cell base station, and UE 115 may be UE 115 operating in a service area of the small cell base station, which in order to access the small cell base station, would be included in a list of accessible UEs for the small cell base station. Base station 140 may also be a base station of some other type. As shown in FIG. 2, a network entity 105, such as base station 140 may be equipped with antennas 234a through 234t, and UE 115 may be equipped with antennas 252a through 252r for facilitating wireless communications.

At base station 140, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 140 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to network entity 105. At network entity 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

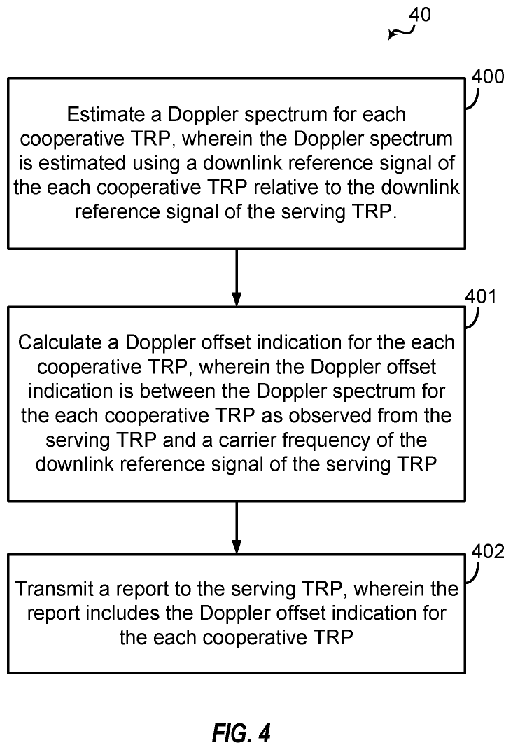

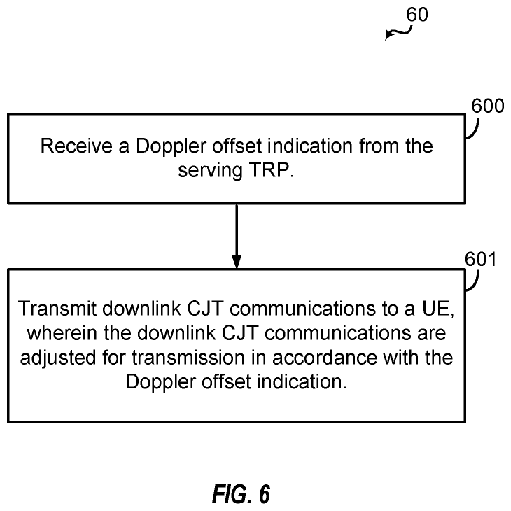

Controllers 240 and 280 may direct the operation at base station 140 and UE 115, respectively. Controller 240 or other processors and modules at base station 140 or controller 280 or other processors and modules at UE 115 may perform or direct the execution of various processes for the techniques described herein, such as to perform or direct the execution illustrated in FIGS. 4 and 6, or other processes for the techniques described herein. Memories 242 and 282 may store data and program codes for base station 140 and UE 115, respectively. Scheduler 244 may schedule UEs for data transmission on the downlink or the uplink.

In some cases, UE 115 and base station 140 may operate in a shared radio frequency spectrum band, which may include licensed or unlicensed (e.g., contention-based) frequency spectrum. In an unlicensed frequency portion of the shared radio frequency spectrum band, UEs 115 or base station 140 may traditionally perform a medium-sensing procedure to contend for access to the frequency spectrum. For example, UE 115 or base station 140 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, network entities 105 and UEs 115 may be operated by the same or different network operating entities. In some examples, an individual network entity 105 or UE 115 may be operated by more than one network operating entity. In other examples, each network entity 105 and UE 115 may be operated by a single network operating entity. Requiring each network entity 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

One area of future interest may include the enhancement of channel state information (CSI) acquisition for coherent joint-transmission (CJT) that targets use of multiple TRPs operating at FR1. Assumptions for study of such enhancements include ideal backhaul, synchronization, as well as the same number of antenna ports across the group of TRPs. The 3GPP Release 16 (Rel-16) and Release 17 (Rel-17) Type-II codebook provides refinement for CJT in multiple TRP (mTRP) operations that target frequency division duplex (FDD) and associated CSI reporting, and also takes into account the throughput-overhead trade-off. A maximum number of CSI-RS ports per resource may remain the same as in Rel-17, (e.g., up to 32 ports per resource). The CJT eType-II CSI may enable larger numbers of ports for CJT in low-frequency bands, with distributed TRPs/panels. However, a single-TRP/-panel with a 32 port antenna array size may be too large for practical deployment.

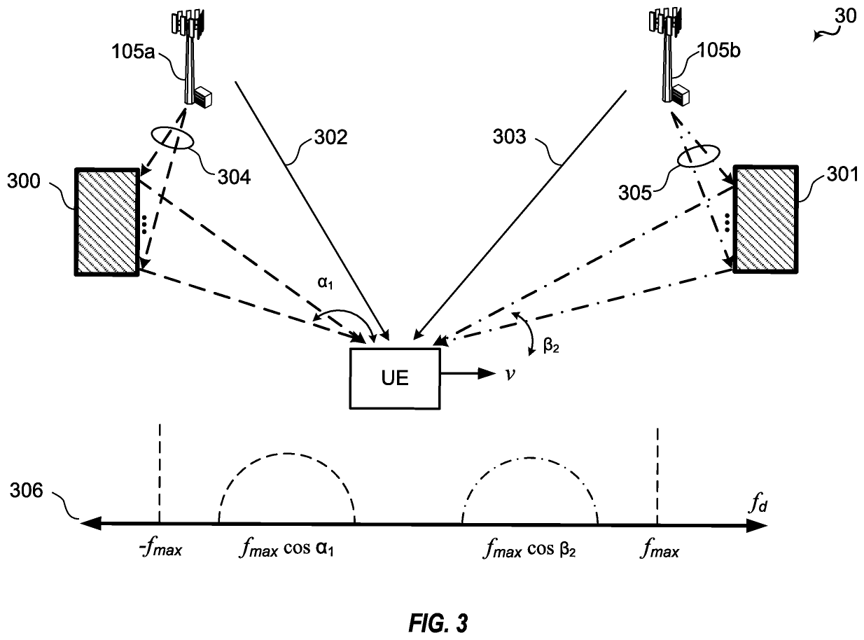

FIG. 3 is a block diagram illustrating a wireless network 30 having a UE 115 in CJT communications with multiple TRPs each entity capable of supporting Doppler offset reporting for CJT communications according to aspects of the present disclosure. TRP 105a is the serving TRP with UE 115, while TRP 105b is a cooperative TRP in the mTRP CJT communications. Transmissions between TRPs 105a and 105b and UE 115 may include both direct, line-of-sight path transmissions, such as signal rays 302 and 303, and reflected signal rays, such as clusters 304 and 305, each of which include multiple signals rays that reflect off of physical objects 300 and 301, respectively, at different times and different angles. Physical objects 300 and 301 may include various objects, such as buildings, geographical features, trees, and the like that cause a reflection of the radio frequency (RF) transmission. The signal rays within clusters 304 and 305 may be received at UE 115 at different times than signal rays 302 and 303. Additionally, UE 115 is in motion in a particular direction at a velocity, V, which further affects the time and angle at which all signals rays are received at UE 115.

CJT communications involving multiple TRPs relies on MIMO-type transmissions that include each of signal rays 302 and 303 and clusters 304 and 305. Accurate and efficient MIMO transmissions also rely on accurate CSI reporting. However, there is a time gap between the CSI calculation at UE 115 and the CSI application at TRPs 105a and/or 105b. CSI may become outdated if the time domain selectivity of the channel is large enough. According to the Wiener-Khinchin theorem, a channel's time domain correlation may correspond to a Fourier transform of the Doppler spectrum. Frequency spectrum 306 reflects the Doppler spectrum associated with the communications associated with TRPs 105a and 105b. Each Doppler spectrum component corresponds with a ray or path. The Doppler frequency may be represented in general according to the equation:

$${f}_{d} = \frac{v}{c} f cos θ , \qquad ( 1 )$$

where v is velocity of UE 115, c is the speed of the light, f is the carrier frequency, and θ is the angle between the arrival direction of the signal ray and the direction of movement of UE 115.

The Doppler spectrum of CJT channels may comprise multiple segments, within a maximum Doppler frequency bandwidth (e.g., −fₘₐₓ to fₘₐₓ), that correspond to each TRP within the cooperating group of TRPs 105a and 105b. A wider Doppler-spectrum results in a stronger time selectivity, which further results in more severe CSI outdating. The channel function, h_{CJT}(t, τ), for such a CJT channel at a particular time delay, τ, may be represented according to the following equation:

$${h}_{CJT} ( t , τ ) = [ {\sum }_{p = 1}^{{N}_{1}} {a}_{p} {e}^{j 2 π \frac{v}{c} f ( cos {α}_{p} ) t} + {\sum }_{q = 1}^{{N}_{2}} {b}_{p} {e}^{j 2 π \frac{v}{c} f ( cos {β}_{q} ) t} ] δ ( τ - {τ}_{n} ) \qquad ( 2 )$$

Where, t corresponds to time, N₁ and N₂ represent the number of signal rays from TRP 105a and 105b, respectively, p and q represent the index of signal rays, respectively, ap and b_{q} represent the signal from TRP 105a and 105b at the p^{th} and q^{th} signal ray, respectively, αₚ represents the angle between the direction of the arrival of the p^{th} signal ray from TRP 105a and the direction of the movement of UE 115 and B_{q} represents the angle between the direction of the arrival of the q^{th} signal ray from TRP 105b and the direction of the movement of UE 115, and δ(τ-τₙ) represents the Dirac delta function over the period (τ-τₙ).

One straightforward solution to the increased time domain selectivity involves configuring more frequent CSI reporting. However, more frequent CSI reporting not only increases CSI-RS overhead at TRPs 105a and 105b, it increases CSI reporting overhead at UE 115, and increases complexity of the calculates that would be performed at UE 115. Various aspects of the present disclosure provide for the reporting of a Doppler offset indication for cooperative TRPs to use to perform time-domain phase rotation offset of further downlink transmissions from the cooperative TRP.

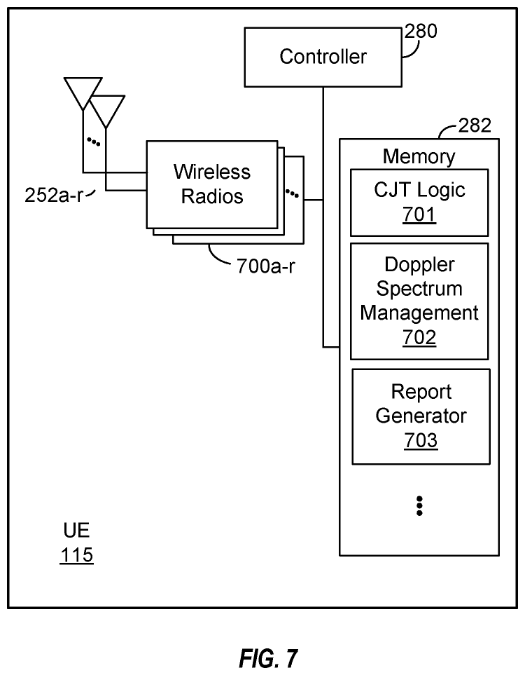

FIG. 4 is a flow diagram illustrating an example process 40 that supports Doppler offset reporting for CJT communications according to one or more aspects. Operations of process 40 may be performed by a UE, such as UE 115 described above with reference to FIGS. 1-3, or a UE described with reference to FIG. 7. For example, example operations (also referred to as “blocks”) of process 40 may enable UE 115 to support power headroom differential reporting for reference resource signals transmitted at different transmission power than other uplink transmissions.

FIG. 7 is a block diagram of an example UE 115 that supports Doppler offset reporting for CJT communications according to one or more aspects. UE 115 may be configured to perform operations, including the blocks of a process described with reference to FIG. 4. In some implementations, UE 115 includes the structure, hardware, and components shown and described with reference to UE 115 of FIGS. 1-2. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 700a-r, antennas 252a-r, and power amplifier 701. Wireless radios 700a-r include various components and hardware, as illustrated in FIG. 2 for UE 115, including modulator and demodulators 254a-r, MIMO detector 256, receive processor 258, transmit processor 264, and TX MIMO processor 266.

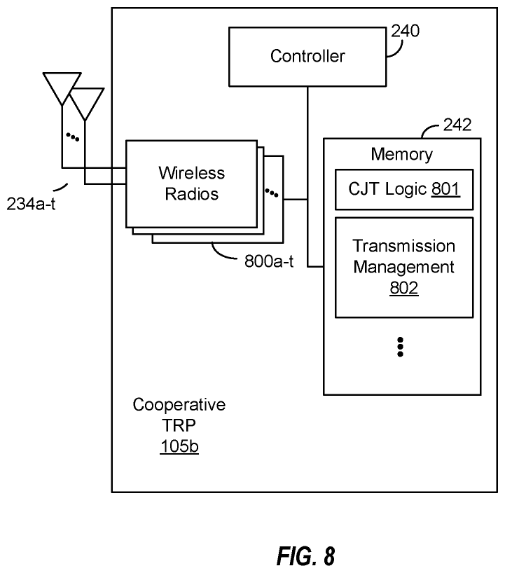

As shown, memory 282 may include CJT logic 701, Doppler spectrum management 702, and report generator 703. CJT logic 701 includes the code and instructions, which, when executed by controller 280 (referred to as the “execution environment” of CJT logic 701), enables the functionality of UE 115 to perform CJT communications with multiple TRPs. Doppler spectrum management 702 includes logic executable under control of controller 280, which enables UE 115 to measure information regarding received signal rays to calculate, estimate, and manage the Doppler spectrum associated with the group of TRPs engaged in CJT communications with UE 115. Report generator 703 may be configured to generate various reports of information, measurements, or other control information for transmission, via wireless radios 700a-r and antennas 252a-r, to one or more network entities, including one or more TRPs of the group of TRPs engaged in CJT communications with UE 115. UE 115 may receive signals from or transmit signals to one or more network entities, such as network entity 105, base station 140, and cooperative TRP 105b of FIGS. 1-3 or a cooperative TRP 105b, as illustrated in FIG. 8.

In block 400, a UE estimates a Doppler spectrum for each cooperative TRP of the one or more cooperative TRPs, wherein the Doppler spectrum is estimated using a downlink reference signal of the each cooperative TRP relative to the downlink reference signal of the serving TRP. A UE, such as UE 115 executes CJT logic 701, stored in memory 282, under control of controller 280. The execution environment of CJT logic 701 enables CJT communications with multiple TRPs, including a serving TRP and one or more cooperative TRPs. UE 115 may further execute Doppler spectrum management 702, stored in memory 282, under control of controller 280. The execution environment of Doppler spectrum management 702 enables UE 115 to estimate the Doppler spectrum for each of the cooperative TRPs based on downlink reference signals, received via antennas 252a-r and wireless radios 700a-r, such as TRS, CSI-RS, or the like. UE 115 estimates the Dopper spectrum relative to the Doppler spectrum associated with the serving TRP. UE 115 may also estimate the Doppler spectrum associated with the serving TRP based on downlink reference signals (e.g., TRS, CSI-RS, etc.) received from the serving TRP via antennas 252a-r and wireless radios 700a-r.

In block 401, the UE calculates a Doppler offset indication for the each cooperative TRP, wherein the Doppler offset indication is between the Doppler spectrum for the each cooperative TRP as observed from the serving TRP and a carrier frequency of the downlink reference signal of the serving TRP. Within the execution environment of Doppler spectrum management 702, UE 115 may further determine a Doppler offset indication for each cooperative TRP, which identifies an offset between the Doppler spectrum associated with the cooperative TRP and the carrier frequency of the serving TRP, as determined by a downlink reference signal (e.g., TRS, CSI-RS, etc.) received from the serving TRP. The execution environment of Doppler spectrum management 702 may configure UE 115 to calculate the Doppler offset indication using different means for identifying the Doppler offset. For example, UE 115 may calculate the Doppler offset for a cooperative TRP as a center frequency of the Doppler spectrum associated with the cooperative TRP, as a power-weighted mean frequency of the Doppler spectrum associated with the cooperative TRP, as a root-mean-square (r.m.s.) Doppler frequency of the Doppler spectrum associated with the cooperative TRP, and the like.

In block 402, the UE transmits a report to the serving TRP, wherein the report includes the Doppler offset indication for the each cooperative TRP. UE 115, under control of controller 280, executes report generator 703, stored in memory 282. The execution environment of report generator 703 enables UE 115 to generate various reports for transmission to network entities, such as the serving TRP or other cooperative TRPs in CJT communications with UE 115. UE 115 may transmit the Doppler offset indication to the serving TRP via wireless radios 700a-r and antennas 252a-r.

As described with reference to FIG. 3, the present disclosure provides techniques for Doppler offset reporting for CJT communications. The problem of outdated CSI in CJT communications can be greatly alleviated or even completed solved. More precise and “less outdated” CSI can improve the system performance of CJT communications. Compared to the conventional solution of increasing the frequency of CSI reporting, implementing the reporting of Doppler offset indications can reduce CSI-RS overhead, can reduce CSI reporting overhead, and can reduce UE computational complexity.

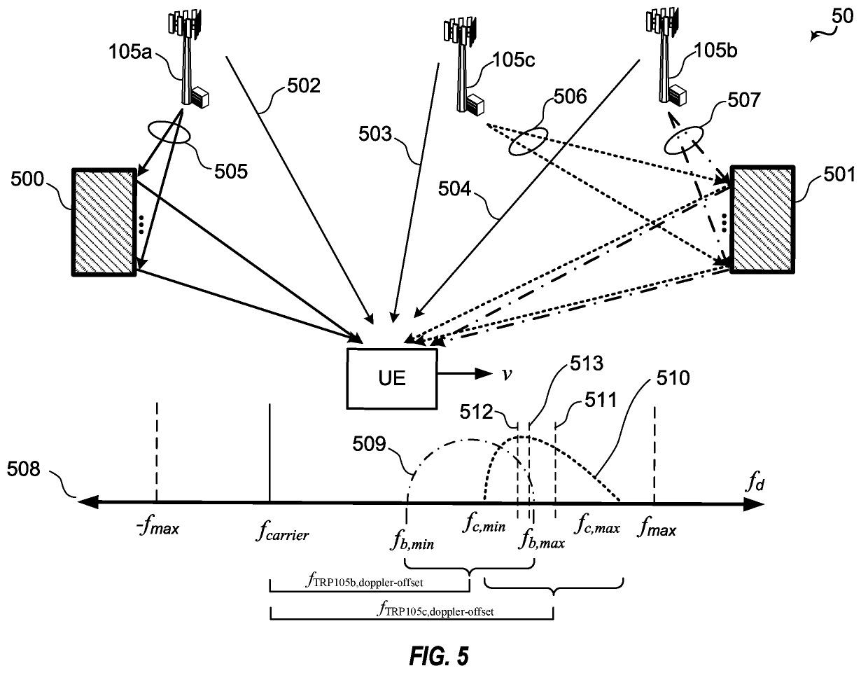

FIG. 5 is a block diagram illustrating a wireless network 30 having a UE 115 in CJT communications with multiple TRPs each entity supporting Doppler offset reporting for CJT communications according to one or more aspects. TRP 105a is the serving TRP with UE 115, while TRPs 105b and 105c are a cooperative TRPs in the mTRP CJT communications. Transmissions between TRPs 105a-c and UE 115 may include both direct, line-of-sight path transmissions, such as signal rays 502-504, and reflected signal rays, such as clusters 505-507, each of which include multiple signals rays that reflect off of physical objects 500 and 501, respectively. UE 115 is in motion in a particular direction at a velocity, V. Frequency spectrum 508 reflects the Doppler spectrum of CJT channels that correspond to each TRP within the cooperating group of TRPs 105a-c.

UE 115 estimates a Doppler spectrum, within a maximum Doppler frequency bandwidth (e.g., −fₘₐₓ to fₘₐₓ), for each cooperative TRP, TRPs 105b and 105c using a downlink reference signal (e.g., TRS, CSI-RS, etc.) from TRPs 105b and 105c, respectively. UE 115 performs carrier synchronization based on the serving TRP's downlink reference signal (e.g., TRS, CSI-RS, etc.). UE 115 estimates the Doppler spectrum for each of TRP 105b and 105c relative to the downlink reference signal (e.g., TRS, CSI-RS, etc.) of serving TRP 105a. Thus, for each cooperative TRP, TRP 105b and 105c, UE 115 estimates the Doppler spectrum, Doppler spectra 509 and 510, based on the respective cooperative TRPs' downlink reference signal (e.g., TRS, CSI-RS, etc.), while maintaining the synchronized carrier frequency, f_{carrier}, invariant. The synchronized carrier frequency, is based on the serving TRP's, TRP 105a, downlink reference signal (e.g., TRS, CSI-RS, etc.).

UE 115 may then calculate and report to the serving TRP, TRP 105a, on a per-cooperative TRP basis, a Doppler offset indication, which may include a Doppler offset value or its equivalent. For example, UE 115 calculates a Doppler offset indication, f_{TRP105b.doppler-offset}, for Doppler spectrum 509, associated with TRP 105b, and a Doppler offset indication, f_{TRP105c.doppler-offset}, for Doppler spectrum 510, associated with TRP 105c, and may transmit each such calculated Doppler offset indication, f_{TRP105b.doppler-offset} and f_{TRP105c.doppler-offset}, to the serving TRP, TRP 105a.

The estimated Doppler spectrum, such as Doppler spectra 509 and 510, reflects the distribution of power over the different Doppler frequencies. The distribution of power typically results in an asymmetric Doppler spectrum, such as Doppler spectrum 510, associated with TRP 105c. The distribution of power can result in a symmetrical Doppler spectrum, which is represented by Doppler spectrum 509, associated with TRP 105b. Because the power-frequency spread of estimated Doppler spectrum can vary, UE 115 may be configured to calculate or estimate the Doppler offset indication for each cooperative TRP using multiple different procedures. Aspects of the present disclosure may provide that the Doppler offset indication for each cooperative TRP n (denoted by f_{n,doppler-offset}), may be calculated using multiple different means.

In a first optional aspect, the Doppler offset indication may represent a central Doppler frequency, such as according to the following equation:

$${f}_{n , central} = \frac{{f}_{n , min} + {f}_{n , max}}{2} ; \qquad ( 3 )$$

With reference to FIG. 5, the central Doppler frequency of Doppler spectrum 510, for example, may be the frequency at 511. For a symmetric Doppler spectrum, such as Doppler spectrum 509, a center frequency representing the Doppler offset indication may provide a favorable adjustment for further CJT transmissions from the cooperative TRP, such as TRP 105b. However, with an asymmetric Doppler spectrum, such as Doppler spectrum 510, a center frequency Doppler offset indication may not be as favorable as in the symmetric Doppler spectrum scenario. For example, as reflected in Doppler spectrum 510, the power distribution favors the lower Doppler frequencies, therefore, reporting the central frequency may lead to an over-adjustment for CJT communications from TRP 105c.

In a second optional aspect, the Doppler offset indication may represent a power-weighted mean Doppler frequency, such as according to the following equation:

$${f}_{n , m e a n} = \frac{{\sum }_{i = 1}^{N} {f}_{n , i} {P}_{n , i}}{{\sum }_{i = 1}^{N} {P}_{n , i}} ; \qquad ( 4 )$$

Where, f_{n,i} and P_{n,i} are the Doppler frequency and power of the ith strongest ray (a “Doppler component”), and N is an integer configured by a network entity, such as TRPs 105a-105c or predefined in the standards. With reference to FIG. 5, the power-weighted mean Doppler frequency of Doppler spectrum 510, for example, may be the frequency at 512. The power-weighted mean Doppler frequency may provide a more favorable Doppler offset indication for Doppler spectra that may be asymmetric or irregular.

In a third optional aspect, the Doppler offset indication may represent a root-mean-square (r.m.s.) Doppler frequency, such as according to the following equation:

$${f}_{n , r m s} = \sqrt{\frac{{\sum }_{i = 1}^{N} {( {f}_{n , i} - {f}_{n , mean} )}^{2} {P}_{n , i}}{{\sum }_{i = 1}^{N} {P}_{n , i}}} . \qquad ( 5 )$$

With reference to FIG. 5, the r.m.s. Doppler frequency of Doppler spectrum 510, for example, may be the frequency at 513. The r.m.s. Doppler frequency may also provide a more favorable Doppler offset indication for Doppler spectra that also may be asymmetric or irregular.

It should be noted that each of the first, second, and third optional aspects that identify a method for UE 115 to calculate the Doppler offset indication, either as a central Doppler frequency, a power-weighted mean Doppler frequency, or a r.m.s. Doppler frequency may be defined in the standards, in which UE 115 would calculate the Doppler offset indication according to manner defined in the standards. In one optional example, UE 115 may elect to use one of the means defined in the standards based on the capabilities of UE 115. In another optional example, there may be one means defined in the standard that would inform how UE 115 would calculate the Doppler offset indication.

An additional optional aspect may provide for the Doppler offset indication, including the different representations of Doppler offset of the above first, second, and third optional aspects, can be normalized before quantization and reporting. For example, the Doppler offset indication may be normalized against a maximum Doppler frequency,

$$\frac{{f}_{n , X}}{{f}_{max}} .$$

In another example, the Doppler offset indication may be normalized against an OFDM symbol length, f_{n,X}T_{sym} or πf_{n,X}T_{sym} or 2πf_{n,X}T_{sym}, where T_{sym} represents the OFDM symbol length. The normalized Doppler offset indication would then be reported by UE 115 to the serving TRP, TRP 105a.

FIG. 6 is a flow diagram illustrating an example process 60 that supports Doppler offset reporting for CJT communications according to one or more aspects. Operations of process 60 may be performed by a network entity such as network entity 105, cooperative TRP 105b, or base station 140 described above with reference to FIGS. 1-3, or a network entity described with reference to FIG. 8. For example, example operations (also referred to as “blocks”) of process 60 may enable cooperative TRP 105b to support power headroom differential reporting for reference resource signals transmitted at different transmission power than other uplink transmissions.

FIG. 8 is a block diagram of an example network entity 105 that supports Doppler offset reporting for CJT communications according to one or more aspects. Network entity 105 may be configured to perform operations, including the blocks of a process described with reference to FIG. 6. In some implementations, network entity 105 includes the structure, hardware, and components shown and described with reference to network entity 105 or base station 140 of FIGS. 1-2. For example, network entity 105 includes controller 240, which operates to execute logic or computer instructions stored in memory 242, as well as controlling the components of network entity 105 that provide the features and functionality of network entity 105. Network entity 105, under control of controller 240, transmits and receives signals via wireless radios 800a-t and antennas 234a-t. Wireless radios 800a-t include various components and hardware, as illustrated in FIG. 2 for base station 140, including modulator and demodulators 232a-t, MIMO detector 236, receive processor 238, transmit processor 220, and TX MIMO processor 230.

As shown, memory 242 may include CJT logic 801 and transmission management 802. CJT logic 801 includes the code and instructions, which, when executed by controller 240 (referred to as the “execution environment” of CJT logic 801), enables the functionality of cooperative TRP 105b to perform CJT communications with other TRPs and a UE. Transmission management 802 may be configured to use a Doppler offset indication received from another TRP to adjust CJT communications with the UE. Cooperative TRP 105b may receive signals from or transmit signals to one or more network entities, such as network entity 105, TRP 105a/b, or base station 140 of FIGS. 1-3, or a network entity, such as cooperative TRP 105b, as illustrated in FIG. 8.

In block 600, a network entity, such as cooperative TRP 105 in mTRP CJT communications, receives a Doppler offset indication from the serving TRP. Cooperative TRP 105 executes CJT logic 801, stored in memory 242, under control of controller 240. The execution environment of CJT logic 801 enables CJT communications with other TRPs, including a serving TRP and a UE. Within the execution environment of CJT logic 801, cooperative TRP 105 may receive a Doppler offset indication via antennas 234a-t and wireless radios 800a-t from a serving TRP of the group of TRPs, including cooperative TRP 105b, in CJT communications with the UE.

In block 601, the network entity transmits downlink CJT communications to the UE, wherein the downlink CJT communications are adjusted for transmission in accordance with the Doppler offset indication. Cooperative TRP 105b executes transmission management 802, stored in memory 242. Within the execution environment of transmission management 802, cooperative TRP 105b may use the Doppler offset indication to perform an adjust to future CJT communications with the UE. For example, using the Doppler offset indication, within the execution environment of transmission management 802, cooperative TRP 105b may control wireless radios 800a-t and antennas 234a-t to perform a time-domain phase rotation of CJT communications to the UE.

Referring back to FIG. 5, on the network side, UE 115 reports the Doppler offset indication to the serving TRP, TRP 105a. The serving TRP, TRP 105a, shares the corresponding Doppler offset indication with each cooperative TRP, TRPs 105b and 105c. TRPs 105b and 105c may then perform a Doppler compensation to adjust further downlink CJT transmission (e.g., PDSCH, DMRS). Based on the Doppler offset indication reported by UE 115 and relayed by the serving TRP, TRP 105a, each cooperative TRP, TRPs 105b and 105c, may perform Doppler compensation via a series of time-domain phase rotations for further downlink CJT transmission. For example, adjustment of DMRS may be represent according to the equation:

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} ) {e}^{- j 2 π {f}_{n , doppler - {offset}^{T} {sym}^{l}}} \qquad ( 6 )$$

Or adjustment of PDSCH, which may be represented according to the equation:

$${a}_{k , l}^{( p , μ )} {e}^{- j 2 π {f}_{n , doppler - {offset}^{T} {sym}^{l}}} , \qquad ( 7 )$$

where f_{n,doppler-offset} is the Doppler offset indication for the target cooperative TRP, T_{sym} is the length of an OFDM symbol and, e^{-j2πf}^{_{n,doppler-offset}}^{T}^{_{sym}}^{^{l}} represents the time domain phase rotation,

$${a}_{k , l}^{( p , μ )}$$

is the DMKS symbol mapping to antenna port p on a resource element (RE) (k, l) with numerology index μ, and k and l are respectively subcarrier and symbol indices, which may also be known as the coordinate of a RE in the resource grid,

$${β}_{PDSCH}^{DMRS}$$

is a scaling factor to conform with the transmission power specified in the standards in Technical Specification (TS) 38.214, w_{f}(k′), wₜ(l′), Δ and r(m) are also provided in the standards in TS 38.2111. Similar Doppler adjustments may be made to other downlink CJT communication with the UE.

It is noted that one or more blocks (or operations) described with reference to FIGS. 4 and 6 may be combined with one or more blocks (or operations) described with reference to another of the figures. For example, one or more blocks (or operations) of FIG. 4 may be combined with one or more blocks (or operations) of FIG. 3. As another example, one or more blocks associated with FIG. 6 may be combined with one or more blocks associated with FIG. 5. As another example, one or more blocks associated with FIG. 4 or 6 may be combined with one or more blocks (or operations) associated with FIGS. 1-2. Additionally, or alternatively, one or more operations described above with reference to FIGS. 1-2 may be combined with one or more operations described with reference to FIG. 7 or 8.

In one or more aspects, techniques for supporting Doppler offset reporting for CJT communications may include additional aspects, such as any single aspect or any combination of aspects described below or in connection with one or more other processes or devices described elsewhere herein. In one or more aspects, supporting Doppler offset reporting for CJT communications may include a UE configured estimate a Doppler spectrum for each cooperative TRP of the one or more cooperative TRPs, wherein the Doppler spectrum is estimated using a downlink reference signal of the each cooperative TRP relative to the downlink reference signal of the serving TRP, calculate a Doppler offset indication for the each cooperative TRP, wherein the Doppler offset indication is between the Doppler spectrum for the each cooperative TRP as observed from the serving TRP and a carrier frequency of the downlink reference signal of the serving TRP, and transmit a report to the serving TRP, wherein the report includes the Doppler offset indication for the each cooperative TRP.

Additionally, the UE may perform or operate according to one or more aspects as described below. In some implementations, the UE may include at least one processor, and a memory coupled to the processor. The processor may be configured to perform operations described herein with respect to the apparatus. In some other implementations, an apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

A first aspect includes a UE configured for wireless communication and in CJT communication with a serving TRP and one or more cooperative TRPs. The UE includes at least one processor and a memory coupled to the at least one processor, wherein the at least one processor is configured to estimate a Doppler spectrum for each cooperative TRP of the one or more cooperative TRPs, wherein the Doppler spectrum is estimated using a downlink reference signal of the each cooperative TRP relative to the downlink reference signal of the serving TRP; to calculate a Doppler offset indication for the each cooperative TRP, wherein the Doppler offset indication is between the Doppler spectrum for the each cooperative TRP as observed from the serving TRP and a carrier frequency of the downlink reference signal of the serving TRP; and to transmit a report to the serving TRP, wherein the report includes the Doppler offset indication for the each cooperative TRP.

In a second aspect, alone or in combination with the first aspect, wherein the Doppler offset indication includes one of: a central Doppler frequency of the Doppler spectrum measured based on the downlink reference signal of the each cooperative TRP; a power-weighted mean Doppler frequency of the Doppler spectrum measured based on the downlink reference signal of the each cooperative TRP; and a root-mean-square Doppler frequency of the Doppler spectrum measured based on the downlink reference signal of the each cooperative TRP.

In a third aspect, alone or in combination with one or more of the first aspect or the second aspect, wherein the configuration of the at least one processor to calculate the Doppler offset indication includes configuration of the at least one processor to normalize the Doppler offset indication against one of: a maximum Doppler frequency of the Doppler spectrum or a symbol length.

In a fourth aspect, alone or in combination with one or more of the first aspect through the third aspect, wherein the downlink reference signal includes one of: a TRS; or a CSI-RS.

A fifth aspect includes a method of wireless communication performed by a UE in CJT communication with a serving TRP and one or more cooperative TRPs, the method comprising estimating a Doppler spectrum for each cooperative TRP of the one or more cooperative TRPs, wherein the Doppler spectrum is estimated using a downlink reference signal of the each cooperative TRP relative to the downlink reference signal of the serving TRP; calculating a Doppler offset indication for the each cooperative TRP, wherein the Doppler offset indication is between the Doppler spectrum for the each cooperative TRP as observed from the serving TRP and a carrier frequency of the downlink reference signal of the serving TRP; and transmitting a report to the serving TRP, wherein the report includes the Doppler offset indication for the each cooperative TRP.

In a sixth aspect, alone or in combination with the fifth aspect, wherein the Doppler offset indication includes one of: a central Doppler frequency of the Doppler spectrum measured based on the downlink reference signal of the each cooperative TRP; a power-weighted mean Doppler frequency of the Doppler spectrum measured based on the downlink reference signal of the each cooperative TRP; and a root-mean-square Doppler frequency of the Doppler spectrum measured based on the downlink reference signal of the each cooperative TRP.

In a seventh aspect, alone or in combination with one or more of the fifth aspect or the sixth aspect, wherein the calculating the Doppler offset indication includes: normalizing the Doppler offset indication against one of: a maximum Doppler frequency of the Doppler spectrum or a symbol length.

In an eighth aspect, alone or in combination with one or more of the fifth aspect through the seventh aspect, wherein the downlink reference signal includes one of: a TRS; or a CSI-RS.

A ninth aspect includes a UE configured for wireless communication and in CJT communication with a serving TRP and one or more cooperative TRPs, the UE comprising: means for estimating a Doppler spectrum for each cooperative TRP of the one or more cooperative TRPs, wherein the Doppler spectrum is estimated using a downlink reference signal of the each cooperative TRP relative to the downlink reference signal of the serving TRP; means for calculating a Doppler offset indication for the each cooperative TRP, wherein the Doppler offset indication is between the Doppler spectrum for the each cooperative TRP as observed from the serving TRP and a carrier frequency of the downlink reference signal of the serving TRP; and means for transmitting a report to the serving TRP, wherein the report includes the Doppler offset indication for the each cooperative TRP.

In a tenth aspect, alone or in combination with the ninth aspect, wherein the Doppler offset indication includes one of: a central Doppler frequency of the Doppler spectrum measured based on the downlink reference signal of the each cooperative TRP; a power-weighted mean Doppler frequency of the Doppler spectrum measured based on the downlink reference signal of the each cooperative TRP; and a root-mean-square Doppler frequency of the Doppler spectrum measured based on the downlink reference signal of the each cooperative TRP.

In an eleventh aspect, alone or in combination with one or more of the ninth aspect or the tenth aspect, wherein the means for calculating the Doppler offset indication includes: means for normalizing the Doppler offset indication against one of: a maximum Doppler frequency of the Doppler spectrum or a symbol length.

In a twelfth aspect, alone or in combination with one or more of the ninth aspect through the eleventh aspect, wherein the downlink reference signal includes one of: a TRS or a CSI-RS.

A thirteenth aspect includes a non-transitory computer-readable medium having program code recorded thereon, the program code comprising program code executable by a computer for causing the computer to: estimate, by a UE in CJT communication with a serving TRP and one or more cooperative TRPs, a Doppler spectrum for each cooperative TRP of one or more cooperative TRPs, wherein the Doppler spectrum is estimated using a downlink reference signal of the each cooperative TRP relative to the downlink reference signal of the serving TRP; calculate, by the UE, a Doppler offset indication for the each cooperative TRP, wherein the Doppler offset indication is between the Doppler spectrum for the each cooperative TRP as observed from the serving TRP and a carrier frequency of the downlink reference signal of the serving TRP; and transmit, by the UE, a report to the serving TRP, wherein the report includes the Doppler offset indication for the each cooperative TRP.

In a fourteenth aspect, alone or in combination with the thirteenth aspect, wherein the Doppler offset indication includes one of: a central Doppler frequency of the Doppler spectrum measured based on the downlink reference signal of the each cooperative TRP; a power-weighted mean Doppler frequency of the Doppler spectrum measured based on the downlink reference signal of the each cooperative TRP; and a root-mean-square Doppler frequency of the Doppler spectrum measured based on the downlink reference signal of the each cooperative TRP.

In a fifteenth aspect, alone or in combination with the thirteenth aspect or the fourteenth aspect, wherein the program code executable by the computer for causing the computer to calculate the Doppler offset indication includes program code executable by the computer for causing the computer to: normalize the Doppler offset indication against one of: a maximum Doppler frequency of the Doppler spectrum or a symbol length.

In a sixteenth aspect, alone or in combination with the thirteenth aspect through the fifteenth aspect, wherein the downlink reference signal includes one of: a TRS or a CSI-RS.

In one or more aspects, techniques for supporting Doppler offset reporting for CJT communications may include additional aspects, such as any single aspect or any combination of aspects described below or in connection with one or more other processes or devices described elsewhere herein. One or more aspects, supporting Doppler offset reporting for CJT communications, may include a network entity configured to receive a Doppler offset indication from a serving TRP, and transmit downlink CJT communications to the UE, wherein the downlink CJT communications are adjusted for transmission in accordance with the Doppler offset indication.

Additionally, the network entity may perform or operate according to one or more aspects as described below. In some implementations, the network entity includes a wireless device, such as a TRP or base station. In some implementations, the network entity may include at least one processor, and a memory coupled to the processor. The processor may be configured to perform operations described herein with respect to the apparatus. In some other implementations, the network entity may include a non-transitory computer-readable medium having program code recorded thereon and the program code may be executable by a computer for causing the computer to perform operations described herein with reference to the apparatus. In some implementations, the network entity may include one or more means configured to perform operations described herein. In some implementations, a method of wireless communication may include one or more operations described herein with reference to the network entity.

A seventeenth aspect includes a cooperative TRP configured for wireless communication and in CJT communication with a serving TRP and a UE. The cooperative TRP includes at least one processor; and a memory coupled to the at least one processor, wherein the at least one processor is configured to: receive a Doppler offset indication from the serving TRP; and transmit downlink CJT communications to the UE, wherein the downlink CJT communications are adjusted for transmission in accordance with the Doppler offset indication.

In an eighteenth aspect, alone or in combination with a seventeenth aspect, further including configuration of the at least one processor to: calculate a time-domain phase rotation using the Doppler offset indication, wherein the configuration of the at least one processor to transmit the downlink CJT communications includes configuration of the at least one processor to transmit the downlink CJT communications adjusted according to the time-domain phase rotation.

In a nineteenth aspect, alone or in combination with one or more of the seventeenth aspect or the eighteenth aspect, further including configuration of the at least one processor to: transmit a downlink reference signal, wherein the Doppler offset indication is based on at least the downlink reference signal and a downlink reference signal associated with the serving TRP.

In a twentieth aspect, alone or in combination with one or more of the seventeenth aspect through the nineteenth aspect, wherein the downlink reference signal includes one of: a TRS or a CSI-RS.

A twenty-first aspect includes a method of wireless communication performed by a cooperative TRP configured for wireless communication and in CJT communication with a serving TRP and a UE, the method includes receiving a Doppler offset indication from the serving TRP; and transmitting downlink CJT communications to the UE, wherein the downlink CJT communications are adjusted for transmission in accordance with the Doppler offset indication.

In a twenty-second aspect, alone or in combination with the twentieth aspect, further including: calculating a time-domain phase rotation using the Doppler offset indication, wherein the transmitting the downlink CJT communications includes transmitting the downlink CJT communications adjusted according to the time-domain phase rotation.

In a twenty-third aspect, alone or in combination with one or more of the twentieth aspect through the twenty-second aspect, further including: transmitting a downlink reference signal, wherein the Doppler offset indication is based on at least the downlink reference signal and a downlink reference signal associated with the serving TRP.

In a twenty-fourth aspect, alone or in combination with one or more of the twentieth aspect through the twenty-third aspect, wherein the downlink reference signal includes one of: a TRS or a CSI-RS.

A twenty-fifth aspect includes a cooperative TRP configured for wireless communication and in CJT communication with a serving TRP and a UE, the cooperative TRP includes means for receiving a Doppler offset indication from the serving TRP; and means for transmitting downlink CJT communications to the UE, wherein the downlink CJT communications are adjusted for transmission in accordance with the Doppler offset indication.

In a twenty-sixth aspect, alone or in combination with the twenty-fifth aspect, further including: means for calculating a time-domain phase rotation using the Doppler offset indication, wherein the transmitting the downlink CJT communications includes transmitting the downlink CJT communications adjusted according to the time-domain phase rotation.

In a twenty-seventh aspect, alone or in combination with one or more of the twenty-fifth aspect or the twenty-sixth aspect, further including: means for transmitting a downlink reference signal, wherein the Doppler offset indication is based on at least the downlink reference signal and a downlink reference signal associated with the serving TRP.

In a twenty-eighth aspect, alone or in combination with one or more of the twenty-fifth aspect through the twenty-seventh aspect, wherein the downlink reference signal includes one of: a TRS or a CSI-RS.

A twenty-ninth aspect includes a non-transitory computer-readable medium having program code recorded thereon. The program code comprising program code executable by a computer for causing the computer to receive, by a cooperative TRP in CJT communication with a serving TRP and a UE, a Doppler offset indication from the serving TRP; and transmit, by the cooperative TRP, downlink CJT communications to the UE, wherein the downlink CJT communications are adjusted for transmission in accordance with the Doppler offset indication.

The thirtieth aspect, alone or in combination with the twenty-ninth aspect, further including program code executable by the computer for causing the computer to: calculate a time-domain phase rotation using the Doppler offset indication, wherein the program code executable by the computer for causing the computer to transmit the downlink CJT communications includes program code executable by the computer for causing the computer to transmit the downlink CJT communications adjusted according to the time-domain phase rotation.

In a thirty-first aspect, alone or in combination with one or more of the twenty-ninth aspect or the thirtieth aspect, further including program code executable by a computer for causing the computer to: transmit a downlink reference signal, wherein the Doppler offset indication is based on at least the downlink reference signal and a downlink reference signal associated with the serving TRP.

In a thirty-second aspect, alone or in combination with one or more of the twenty-ninth aspect through the thirty-first aspect, wherein the downlink reference signal includes one of: a TRS or a CSI-RS.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A user equipment (UE) configured for wireless communication and in coherent joint-transmission (CJT) communication with a serving transmission-reception point (TRP) and one or more cooperative TRPs, the UE comprising:
at least one processor; and
a memory coupled to the at least one processor,
wherein the at least one processor is configured to:
estimate a Doppler spectrum for each cooperative TRP of the one or more cooperative TRPs, wherein the Doppler spectrum is estimated using a downlink reference signal of the each cooperative TRP relative to the downlink reference signal of the serving TRP;
calculate a Doppler offset indication for the each cooperative TRP, wherein the Doppler offset indication is between the Doppler spectrum for the each cooperative TRP as observed from the serving TRP and a carrier frequency of the downlink reference signal of the serving TRP; and
transmit a report to the serving TRP, wherein the report includes the Doppler offset indication for the each cooperative TRP.

2. The UE of claim 1, wherein the Doppler offset indication includes one of:
a central Doppler frequency of the Doppler spectrum measured based on the downlink reference signal of the each cooperative TRP;
a power-weighted mean Doppler frequency of the Doppler spectrum measured based on the downlink reference signal of the each cooperative TRP; and
a root-mean-square Doppler frequency of the Doppler spectrum measured based on the downlink reference signal of the each cooperative TRP.

3. The UE of claim 2, wherein the configuration of the at least one processor to calculate the Doppler offset indication includes configuration of the at least one processor to:
normalize the Doppler offset indication against one of: a maximum Doppler frequency of the Doppler spectrum or a symbol length.

4. The UE of claim 1, wherein the downlink reference signal includes one of:
a tracking reference signal (TRS); or
a channel state information-reference signal (CSI-RS).

5. A cooperative transmission-reception point (TRP) configured for wireless communication and in coherent joint-transmission (CJT) communication with a serving TRP and a user equipment (UE), the cooperative TRP comprising:
at least one processor; and
a memory coupled to the at least one processor,
wherein the at least one processor is configured to:
receive a Doppler offset indication from the serving TRP; and
transmit downlink CJT communications to the UE, wherein the downlink CJT communications are adjusted for transmission in accordance with the Doppler offset indication.

6. The cooperative TRP of claim 5, further including configuration of the at least one processor to:
calculate a time-domain phase rotation using the Doppler offset indication, wherein the configuration of the at least one processor to transmit the downlink CJT communications includes configuration of the at least one processor to transmit the downlink CJT communications adjusted according to the time-domain phase rotation.

7. The cooperative TRP of claim 5, further including configuration of the at least one processor to:
transmit a downlink reference signal, wherein the Doppler offset indication is based on at least the downlink reference signal and a downlink reference signal associated with the serving TRP.

8. The cooperative TRP of claim 7, wherein the downlink reference signal includes one of:
a tracking reference signal (TRS); or
a channel state information-reference signal (CSI-RS).

9. A method of wireless communication performed by a user equipment (UE) in coherent joint-transmission (CJT) communication with a serving transmission-reception point (TRP) and one or more cooperative TRPs, the method comprising:
estimating a Doppler spectrum for each cooperative TRP of the one or more cooperative TRPs, wherein the Doppler spectrum is estimated using a downlink reference signal of the each cooperative TRP relative to the downlink reference signal of the serving TRP;
calculating a Doppler offset indication for the each cooperative TRP, wherein the Doppler offset indication is between the Doppler spectrum for the each cooperative TRP as observed from the serving TRP and a carrier frequency of the downlink reference signal of the serving TRP; and
transmitting a report to the serving TRP, wherein the report includes the Doppler offset indication for the each cooperative TRP.

10. The method of claim 9, wherein the Doppler offset indication includes one of:
a central Doppler frequency of the Doppler spectrum measured based on the downlink reference signal of the each cooperative TRP;
a power-weighted mean Doppler frequency of the Doppler spectrum measured based on the downlink reference signal of the each cooperative TRP; and
a root-mean-square Doppler frequency of the Doppler spectrum measured based on the downlink reference signal of the each cooperative TRP.

11. The method of claim 10, wherein the calculating the Doppler offset indication includes:
normalizing the Doppler offset indication against one of: a maximum Doppler frequency of the Doppler spectrum or a symbol length.

12. The method of claim 9, wherein the downlink reference signal includes one of:
a tracking reference signal (TRS); or
a channel state information-reference signal (CSI-RS).

13-16. (canceled)
